(19) United States
(12) Patent Application Publication
(10) Pub. No.: US 2015/0146314 A1
(43) Pub. Date: May 28, 2015

(54) SOLAR COLLECTOR MODULE

(71) Applicant: Rolf Niemeyer, Gut Neuhöfchen, Grevenbroich (DE)

(72) Inventor: Rolf Niemeyer, Gut Neuhöfchen, Grevenbroich (DE)

(73) Assignee: FLABEG HOLDING GMBH, Furth im Wald (DE)

(21) Appl. No.: 14/116,580

(22) PCT Filed: Mar. 26, 2012
(86) PCT No.: PCT/EP2012/001312

§ 371 Date: Dec. 22, 2014

(30) Foreign Application Priority Data
May 10, 2011 (DE) 10 2011 101 082.7

(51) Int. Cl. G02B 19/00; G02B 7/183; G02B 5/09

(52) U.S. Cl. CPC G02B 19/0042; G02B 19/0023; G02B 5/09; G02B 7/183
USPC 359/853

(57) ABSTRACT

A solar collector module has a support frame provided for attachment of a number of reflector elements forming a parabolic trough when viewed in a longitudinal direction, wherein on each of the end faces the support frame has, when viewed in the longitudinal direction, a respective coupling plate, which is provided with a number of adjusting elements, for connection to the support frame of a neighbouring module. The coupling plates are designed in pairs with regard to the adjusting elements thereof in such a way that the adjusting elements of the first coupling plate each have a reference bearing surface for a contact surface of an adjusting element of the second coupling plate.

The invention relates to a solar collector module with a support frame for attaching a number of reflector elements forming a parabolic trough as viewed in a longitudinal direction, which on its two end sides as viewed in the longitudinal direction have a coupling plate for connection to the support frame of an adjacent module. It further relates to a parabolic trough power plants with a plurality of such in the longitudinal direction successively arranged solar collector modules.

In the context of so-called parabolic trough power plants conventionally parabolic solar collector modules each having a number of reflector elements are used, which are arranged in their entirety on a common support frame for forming a parabolic mirror. The solar collector modules are usually aligned in north-south direction and uniaxially follow the sun, and the reflector elements concentrate the incident solar radiation onto the absorber tube extending in the focal line due to their arrangement to form a parabolic mirror. In the absorber tube running in the focal line temperatures of up to 550° C. can thus be achieved. The heat thereby introduced into the absorber tube can be withdrawn via a working fluid and converted by connected heat exchanger, for example, into hot steam that drives generators coupled with the use of conventional power plant technology. In this way, such parabolic trough power plants form solar power plants for central current generation, and depending on the design and positioning of the plant power ranges for example between 10 and 100 MW or more are achievable. By successively connecting a plurality of solar collector modules of the type mentioned collectors can be formed for example with a total length of up to 150 m.

For such parabolic trough power plants, a high efficiency is generally desired design objective. For this purpose, among others, the highly accurate alignment of the reflector elements provided for formation of the parabolic mirror on their support frame and also of the individual collector elements or modules to each other are of particular importance. The requirements for the accuracy of alignment concern, in particular, the rotation of the transverse axis (conventionally “x-axis”) of the individual collectors elements around the axis of rotation of the collector (“y-axis”). Deviations of a few mrad can namely result in that a plurality of rays reflected by the reflector miss the absorber tube and their radiation energy cannot be used.

For the desired highly accurate alignment usually, in addition to a final orientation of the individual modules in the solar field, that is directly on the final place of use, also in the manufacturing line, that is during the pre-assembly, an accurate horizontal alignment of the x-axis of the respective collector module, and its transfer from one mounting device to a next one is provided. Three major assembly steps can be provided in particular: 1. Assembly of the so-called torque box as the central support element of the support frame; 2. Assembly of laterally projecting support arm; 3. Assembly of the mirror and the supports for the receiver tubes. In all three assembly steps, the resulting collector element has the same axis of rotation (y-axis) as a reference axis and the same horizontal alignment of the x-axis, to ensure that the bores designed for a certain manufacturing tolerance have sufficient overlap to assemble other components in the desired position. For transfer of these reference points usually so called beams can be used, which correspondingly have precisely manufactured bearing elements and can be flanged at both ends of a collector element rotationally rigid about the y-axis.

The assembly process usually provides here that within the assembly line at each end of the resulting collector module within the first assembly step (usually the torque box) the beams are attached, which are aligned horizontally by means of precision water levels and attached to the collector module. The alignment of the collector module may then be transmitted over the reference body to the beam from one assembly device to the next one. Reference blocks are also mounted on the support structure of the collector module against corresponding precisely machined surfaces to define the horizontal alignment at the collector module for later use. The beams are removed at the end of the assembly line. The reference blocks remain at the collector module and then are used in the solar field or at the final site to set the horizontal alignment of the collector module again. This precision water level on site is placed on the reference blocks, by means of which the collector module can be rotated in the correct horizontal orientation.

Since the parabolic trough power plant comprises as a rule a plurality of such collector modules, they must be suitably coupled to each other in the assembly and aligned to each other. The coupling elements provided for this purpose on the joints between the individual collector elements are generally orthogonal to the collector axis (y-axis. longitudinal axis) mounted coupling plates, which are clamped flatly against each other by means of connecting pins. The friction between the plate surfaces then ensures a force and moment transfer from one solar collector module to another. It is usual that during the assembly and coupling of adjacent modules, first the pivot axes of the collector modules are brought to coincidence by means of a central bolt.

By means of a precision water level, which is placed on the reference blocks, initially one of the collector modules is property aligned and fixed to the drive pylon of the parabolic trough power plant positioned in zenith position. The next solar collection module is then moved to the already oriented one, so that the end plates are located opposite to each other. Then the rotary axes are brought by staking to coincide with a centering pin. The still remaining degree of freedom in the direction of the rotation about the rotational axis is then also aligned horizontally with the aid of a precision water level and by tightening of the connection bolt is fixed to the oriented collector module. This process is repeated according to the number of the collector modules in each parabolic trough collector.

The invention has the object to provide a solar collector module of the type mentioned above, which enables a highly accurate alignment with in particular simply held assembly. Furthermore, a parabolic trough collector must be provided in a particularly simple manner and yet highly accurately mountable.

With respect to the solar collector, this object is achieved in that coupling plates arranged at end side in the longitudinal direction on the support frame are each provided with a number of adjusting elements, wherein the coupling plates are designed in pairs with respect to their adjusting elements, so that the adjusting elements of the first coupling plate in each case have a reference support surface for a counter surface of an adjusting element of the second coupling plate.

The invention is based on the consideration that a simplification of the assembly operations could be achieved in particular in that alignment and positioning steps can be consequently eliminated from the phase of the on-site assembly and be transferred to the preassembly or premanufacture. In particular, to the alignment procedure in the solar field, or on site, with precision water level and reference blocks must be replaced by appropriate calibration steps during the pre-assembly. For this purpose suitable adjustment means must be mounted on the end or coupling plates already on the assembly line at both ends of the collector module. These adjustment elements are then used in the field or on site as coupling and aligning elements and each mounted so that the adjusting elements on the front end of the collector module come with their supporting surface to lie on the reference support surfaces of the corresponding adjustment elements at the rear end of the adjacent collector element. Through appropriate, high-precision alignment of the adjusting elements, already during the pre-assembly a high-precision alignment on site between adjacent modules can be achieved by simple superposition of the mutually corresponding adjustment elements.

To achieve the lowest possible impact of possible manufacturing or positioning inaccuracies of the adjusting elements on the angular orientation, two adjusting elements, as seen in top view of the respective coupling plate are arranged advantageously on the coupling plates symmetrically to the center axis and thus in particular mirror-symmetrical to the y-z plane of the parabolic trough collector arranged in end outer region of the corresponding coupling plate. In particular by the arrangement of the adjusting elements very far out, in particular very far from the central axis, the impact of manufacturing or positioning inaccuracies of the adjusting elements on the rotational orientation of the mirror support system around the y-axis can be kept particularly low.

A particularly high ease of assembly for the system is reachable when reference support surfaces formed by the adjustment elements as seen in cross section are located parallel to the x-axis of the collector, and in a particularly preferred development the reference contact surfaces are aligned parallel to the focal plane of the parabolic trough formed by the reflector elements, therefore parallel to the x-y plane of the system. With avoiding a mechanical over-determination of system slight tolerances can be taken into account in the x-y direction. During assembly in the field, that is during the assembly of adjacent modules, the y-axis is preferably set by inserting a centering pin in the respective coupling plate. However the fits may be provided in order not to generate overdetermination between the assembly blocks and the centering pin. For the optical efficiency of the collector it is essentially important how accurately the x-axis is aligned. A slight offset of the y-axis because of the play on the centering has negligible impact on the optical quality of the collector, and the highly accurate alignment in the x-direction.

A further facilitation of the assembly is achievable in that the system is fit for certain insignificant tolerances also with respect rotations around y-axis. To enable this the reference support surfaces formed by the adjusting elements of the first coupling plate have a smaller lateral extension than the associated contact surface of the adjusting element of the second coupling plate. By pairing of the reference support surface of the first coupling plate of the first module with the contact surface of the second coupling plate of the adjacent module during the assembly the contact surfaces of different widths in x-direction are placed over one another. The relatively smaller width of the (located below) reference abutment surface allows in a small extent a slight tilting during placement of the second contact surface.

During the assembly on site, in the solar field, the connection between adjacent solar collector modules with each other is produced preferably with bolts via a suitable hole pattern, in particular the hole pattern in the coupling plates allowing a certain fine adjustment of the rotational alignment of the modules relative to one another. To have the possibility of a post adjustment there and during suspending the solar collector module in the solar field in case of need, in a preferable embodiment a number of the adjustment elements have each an adjusting pin guided in a threaded channel. For formation of the threaded channels, through threaded holes are provided in the adjusting elements of the first coupling plate preferably constructed as contact blocks, which serve for receiving a threaded pin. It is thereby possible to provide a smaller distance between the contact blocks of the both coupling plates connectable with one another and therefore to incline the respective solar collector module in case of need slightly around the y-axis.

In particularly advantageous embodiment the adjusting elements are formed each as contact blocks mounted on the respective coupling plate.

With regard to the parabolic trough collector with a plurality of solar collector modules of the mentioned type arranged in longitudinal direction one after the other, the mentioned objective is solved in that adjacent solar collector modules are connected with each other via their coupling plates facing each other. During the assembly preferably a drive pylon (later standing in a middle) is erected, which is equipped on both sides with coupling plates of the first type, provided with the adjusting elements with reference support surfaces. Then on both sides of the drive pylon solar collector modules are mirror-symmetrically suspended, each with a coupling plate of a second type, provided with adjusting elements with contact surfaces associated with the reference support surfaces. During assembly the contact surfaces (of the new-to-assembled module) are placed on the reference support surfaces (of the already assembled first coupling plate), whereby also a high-precision fine adjustment of the module is provided as a result of the surface contact of the adjustment elements. Then further modules are assembled on both sides on the “still free” ends of the newly installed module, using the coupling plates, as long as the desired length or number of the modules of the parabolic through collector is reached. The connection of the modules with one another is produced, as described, via a suitable hole pattern with the help of bolts.

The advantages provided by the invention consist in that with the use of coupling pairs arranged in pairs in form of “plug-socket” or “male-female” combinations with correspondingly designed adjusting elements, in particularly simple and easy-to-install manner a transfer of a high-precision alignment and orientation of adjacent modules relative to one another produced in a pre-assembly can be reproduced during the installation and final assembly on site, without the need for expensive time-consuming fine adjustment on site. Thereby a substantial simplification of the field assembly is reachable, because no adjustment in the field is necessary. Also an increase of the occupational safety in the solar field is provided, because less handling steps with heavy loads are required. Expensive adjusting tools, such as for example water level tools are needed only on the assembly line, while to the contrary during the field assembly only a final inspection of the adjustment in terms of a quality review is provided. The actual alignment and adjustment takes place on the assembly line, so that a lower probability of error due to less interference by environment (wind, heat, etc) is to be expected. The same shaping of exactly measured assembly devices and with the help of high-precision beams ensures consistent alignment quality.

An exemplary embodiment of the invention is explained with reference to a drawing. It is shown in:

FIG. 1 a parabolic trough collector with a number of solar collector modules

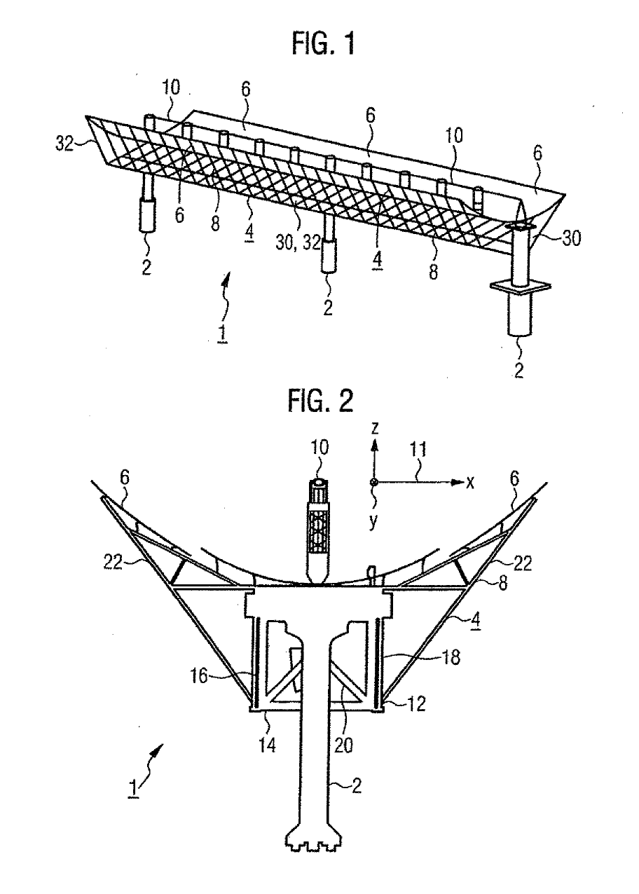

FIG. 2 the parabolic trough collector according to FIG. 1 in cross section,

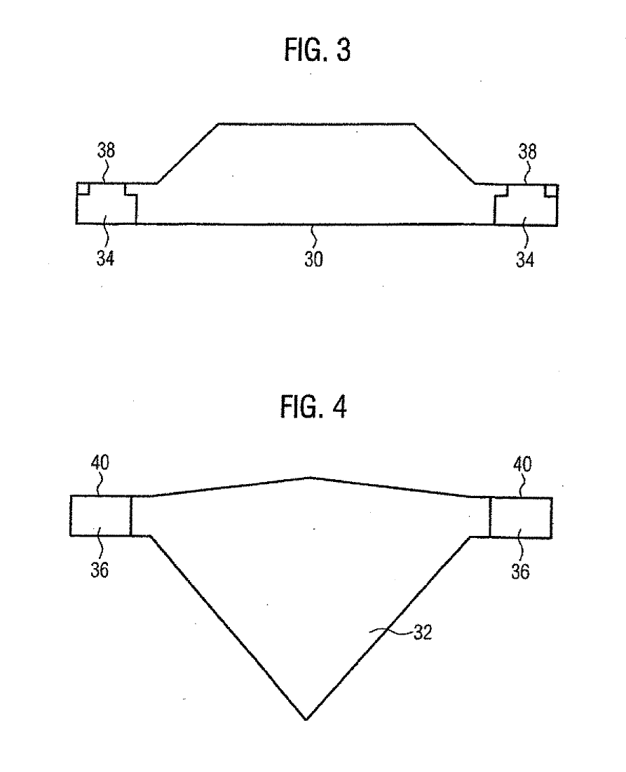

FIGS. 3, 4 schematically a coupling plate of a solar collector module of the parabolic trough collector according to FIG. 1,

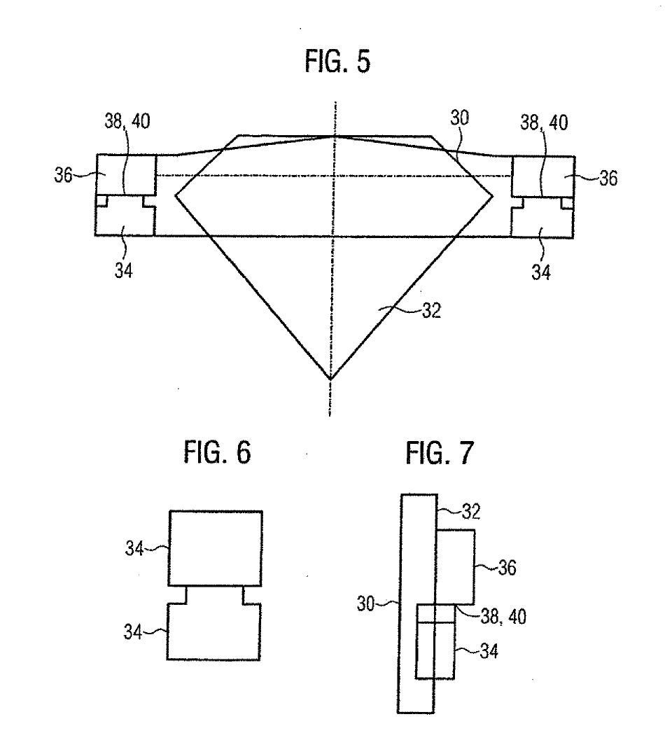

FIG. 5 the coupling plates of FIGS. 3 and 4 superimposed,

FIG. 6 adjusting elements of the coupling plates of FIGS. 3, 4,

FIG. 7 the superimposed coupling plates of FIG. 5 in side view,

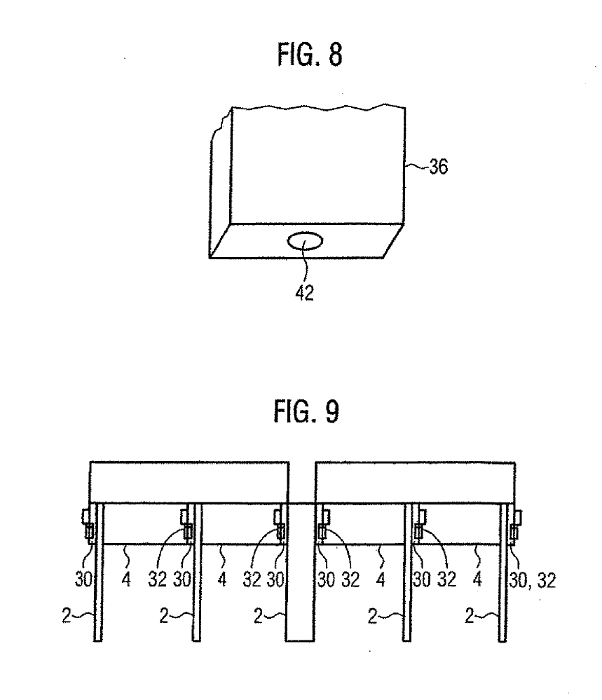

FIG. 8 an adjusting element in a view from below, and

FIG. 9 the parabolic trough collector of FIG. 1 schematically in longitudinal section.

Same parts are provided in all Figures with same reference characters

The parabolic trough collector 1 according to FIG. 1 is provided for use in a so-called parabolic trough power plant. It includes a plurality of solar collector modules 4 which are arranged adjacent to one another and supported on pylons 2 (drive or support pylons). Each solar collector module 4 includes a number of reflector elements 6, which in their entirety form a parabolic mirror in each solar collector module 4 and for this are arranged on a support frame 8. In the parabolic trough collector 1 seen in the entirety the parabolic mirrors of the solar collector module 4 form a parabolic trough. The parabolic trough collector 1 is designed for an installation with its longitudinal axis in North-South direction, with the support frame supported swingably so that the parabolic mirror formed by the reflector elements 6 can uniaxially follow the sun with one axis. The parabolic mirror formed by the reflector elements 6 bundles the incoming light on its focal line, in which an absorber tube 10 is arranged. A suitable thermal medium flows through the absorber tube which in not shown way is connected with subsequent power plant components, in which a conversion of the heat introduced by solar radiation into other energy forms is performed.

The support frame 8 in the embodiment according to FIG. 1 is made in form of a so-called torsion box. This torsion box is shown in FIG. 2 in detail. In addition to illustration of the suitably used coordinates in FIG. 2 a coordinate system 11 with the substantially main directions is shown. With the coordinate system 11 (which during swiveling of the solar collector module 4 swivels around its swivel axis extending parallel to the absorber tube 10 with the solar collector module) taken out, the x-direction runs along the focal plane of the parabolic trough formed by the reflector elements 6. The z-direction however runs orthogonal to this focal plane, so that the parabolas in cross section formed by the reflector elements 6 extend in the x-z plane. The y-direction extends however parallel to the swivel axis of the solar collector module 4 and thereby also parallel to the absorber tube 10, out from the drawing plane in the cross sectional view according to FIG. 2.

The torsion box includes, as can be seen in FIG. 2, a main support structure 12, which is joined via two arranged in parallel grid elements 14,16 with a rectangular truss structure. The grid elements 14, 16 are connected with one another via encircling braces 18 outside and by cross braces 20 inside and form a box structure with rectangular or square cross sectional surface. A plurality of support arms 22, so called cantilever, are arranged on this main support structure 12 projecting from it, which support the reflector elements 6.

The torsion box of the solar collector module 4 in the exemplary embodiment is formed so that the center of gravity of the whole system, i.e. the reflector elements 6 and the associated torsion box, is located outside the parabolic path of the reflector elements 6. The “outside the parabolic path” means such a region, in which also the torsion box itself is located, at the side of the reflector elements 6 facing away from the absorber tube 10. Such a displacement of the center of gravity outside of the parabolic path is obtained by suitable material selection and suitable arrangement of the support elements of the torsion box. It can be in particular intended to exclude the use of counterweights or additional elements without impact on structural strength of the support system. Such exclusion leads for this torsion box in advantageous embodiment to an especially simple and compact construction.

The solar collector module 4 and thereby also the parabolic trough collector 1 as a whole are specifically designed to allow a high precision alignment with especially simply maintained assembly on site, on immediate place of use. In particular positioning error due to inaccuracies during swiveling of the solar collector module 4 should be largely eliminated or at least kept particularly low. To allow this with still simply held on site assembly, the solar collector modules 4 are designed for a substantial, high-precision alignment and adjustment already during the preassembly, for example in a production hall, and a subsequently simply and securely maintained transfer of the preset alignment during the end mounting in the solar field.

To achieve these design objectives the support frames 8 of the solar collector module 4 are provided on both end sides as seen in the longitudinal direction of the parabolic trough with coupling plates 30, 32 for connection with each adjacent module. The coupling plates 30, 32 are constructed in the way of a plug-socket or “male-female” constellation to use in pair with each other with extensive maintaining of the orientation relative to one another after performed preassembly. Each support frame 8 on the one hand has a first coupling plate provided with a number of adjusting elements 34, for example shown in front view in FIG. 4, and on the other hand has a second coupling plate 32 provided with a number of adjusting elements 36, for example shown in front view in FIG. 5. The adjusting elements 34,36 are designed as support blocks and suitably attached to the corresponding coupling plates 30,32, for example by locking bolts or are welded. With respect to their adjusting elements 34, 36 the coupling plates 30, 32 are executed in pairs so that the adjusting elements 34 of the first coupling plate 30 for a reference support surface 38 form a contact surface 40 of an adjusting element 36 of the second coupling plate 32.

In the exemplary embodiment shown in FIGS. 3, 4 respectively two adjusting elements 34 or 36 are arranged on the coupling plates 30, 32 symmetrically to its central axis as seen in plan view of the respective coupling plate 30, 32 in end side outer region.

Two coupling plates 30, 32 lying over one another, in assembled state during the connection of two adjacent solar collector modules 4 are shown in FIG. 5 in a plan view and in FIG. 7 in a cross section. In this representation on the one hand it can be clearly seen that the contact surfaces 40 of the adjusting elements 36 lay on the reference support surfaces 38 of the adjusting elements 34. Thereby a high-precision alignment of the respective solar collector modules 4 relative to one another carried out in the preassembly in a production hall or the like is reproducible in especially simple and reliable during later field or on site mounting without need for a new adjustment. On the other hand it can be clearly recognized in particular from the representation in FIG. 5 and also from the enlarged representation in FIG. 6, that the reference support surfaces 38 formed by the adjusting elements 34 of the first coupling plate 30 have a smaller lateral extension than the respective associated contact surfaces 40 of the adjusting element 36 of the second coupling plate 32.

To have the possibility of a subsequent adjustment there and during suspension of the solar collector module 4 in the solar field in case of need, at least some of the adjusting elements 34, 36 are each provided with a threaded channel 42, in which a not shown adjustment pin or threaded bolt is guided. To form the threaded channels 42 threaded through bores are made in the adjusting elements 34 of the first coupling plates 30 designed as contact blocks for receiving a threaded bolt as adjusting pin. Thereby it is possible to provide a small distance between the contact blocks of both coupling plates 30, 32 and to incline the respective solar collector module 4 insignificantly around the y-axis in case of need.

The parabolic trough collector 1 with a plurality of solar collector modules 4 of the mentioned type arranged one after the other in longitudinal direction is schematically shown in longitudinal section in FIG. 9. Neighboring solar collector modules 4 are connected with one another through their coupling plates 30, 32 which face each other. During the assembly preferably first one drive pylon (later standing in the middle and identified in FIG. 9 as middle pylon 2) is erected, which at both sides is provided with the coupling plates 30 of the first type, i.e. provided with adjusting elements 34 with the reference support surfaces 38. Then mirror-symmetrically on both sides of the drive pylon solar collector modules 4 are suspended, each with a coupling plate 32 of the second type, i.e. provided with adjusting elements 32 with the contact surfaces 40 associated with the contact surfaces 38. During the assembly the contact surfaces 40 of the new module to be assembled are placed on the reference support surfaces 38 of the already assembled first coupling plates 30, whereby a high precision fine alignment of the module is obtained because of the flat contact of the adjusting elements 34, 36 with one another. Subsequently at both sides on “still free” ends of the new assembled module respective further modules are assembled with use of the coupling plates 30, 32, until the desired length or number of the modules of the parabolic trough collector is reached.

### LIST OF REFERENCE SIGNS

1 parabolic trough collector
2 pylon
4 solar collector module
6 reflector element
8 support frame
10 absorber tube
11 coordinate system
12 main support structure
14, 16 grid element
18 encircling brace
20 cross brace
22 support arm
30, 32 coupling plate
34, 36 adjusting element
38 reference support surface
40 contact surface
42 threaded channel

What is claimed is:

1.-7. (canceled)

8. A solar collector module, comprising:
a support frame having two ends in a longitudinal direction;
a plurality of reflector elements forming a parabolic trough in the longitudinal direction for attachment to the support frame; and
coupling plates respectively provided on the ends of the support frame and having adjusting elements for connection with a support frame of a neighboring solar collection module, said adjusting elements of the coupling plates being arranged in pairs such that the adjusting elements of one of the first coupling plates have a reference support surface for a contact surface of an adjustment element of another one of the coupling plates.

9. The solar collector module of claim 8, wherein the coupling plates each have two adjusting elements which are arranged, as seen in a plan view on the coupling plate, in symmetry to its central axis in an end side region.

10. The solar collector module of claim 8, wherein the reference support surfaces formed by the adjusting elements of the one of the coupling plates are aligned in parallel relationship to a focal plane of the parabolic trough formed by the reflector elements.

11. The solar collector module of claim 8, wherein the reference support surfaces formed by the adjusting elements of the one of the coupling plates have a lateral extension which is smaller than a lateral extension of the contact surface of the adjusting element of the other one of the coupling plates.

12. The solar collector module of claim 8, wherein the adjusting elements each have an adjusting pin guided in a threaded channel.

13. The solar collector module of claim 8, wherein the adjusting elements are designed as support blocks mountable on the coupling plates.

14. A parabolic through collector, comprising a plurality of solar collector modules arranged successively in a longitudinal direction, each said solar collector module including a support frame having two ends in a longitudinal direction, a plurality of reflector elements forming a parabolic trough in the longitudinal direction for attachment to the support frame, and coupling plates respectively provided on the ends of the support frame and having adjusting elements for connection with a support frame of a neighboring solar collection module, said adjusting elements of the coupling plates being arranged in pairs such that the adjusting elements of one of the first coupling plates have a reference support surface for a contact surface of an adjustment element of another one of the coupling plates, wherein neighboring ones of the solar collector modules are connected with one another via their confronting coupling plates.

15. The parabolic trough collector of claim 14, wherein the coupling plates each have two adjusting elements which are arranged, as seen in a plan view on the coupling plate, in symmetry to its central axis in an end side region.

16. The parabolic trough collector of claim 14, wherein the reference support surfaces formed by the adjusting elements of the one of the coupling plates are aligned in parallel relationship to a focal plane of the parabolic trough formed by the reflector elements.

17. The parabolic trough collector of claim 14, wherein the reference support surfaces formed by the adjusting elements of the one of the coupling plates have a lateral extension which is smaller than a lateral extension of the contact surface of the adjusting element of the other one of the coupling plates.

18. The parabolic trough collector of claim 14, wherein the adjusting elements each have an adjusting pin guided in a threaded channel.

19. The parabolic trough collector of claim 14, wherein the adjusting elements are designed as support blocks mountable on the coupling plates.
